(19) United States
(12) Patent Application Publication
(10) Pub. No.: US 2006/0243213 A1
(43) Pub. Date: Nov. 2, 2006

(54) Method and device for providing data on individual animals as well as an installation for herd management

(76) Inventor: Peter Kaever, Oelde (DE)

Correspondence Address: SMITH LAW OFFICE, 440 SCIENCE DR., SUITE 302, MADISON, WI, 53711, US

(21) Appl. No.: 11/399,042

(22) Filed: Apr. 6, 2006

(30) Foreign Application Priority Data
Apr. 18, 2005 (DE) 10 2005 017 909.6

(51) Int. Cl. A01K 29/00

(52) U.S. Cl. 119/174

(57) ABSTRACT

The method according to the invention for providing data on individual animals in which a sample (2) is taken from an animal at a sample location (1), whereby the animal ID is determined for identification of the animal, a registration ID is determined for the identification of the sampling, and a sampling ID is determined for the identification of the sample, is characterized by the fact that the animal ID, the registration ID and the sample ID are determined at the sampling location (1), are linked together to one information unit and are introduced into a data center (3). The method according to the invention, the device as well as the installation, permit efficient, comprehensive and practicable preparation and acquisition of a mass of data on individual animals, which is not liable to error, even in the case of large animal stocks and also permits comprehensive monitoring of an animal throughout the day.

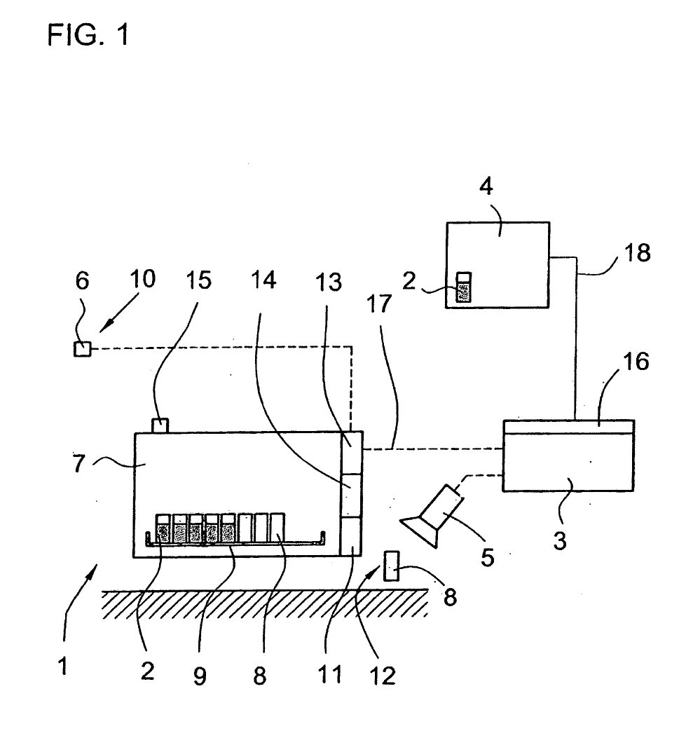

The invention concerns a method and a device for providing data on individual animals, whereby a sample is taken from an animal at a sampling location and an animal ID is determined for identification of the animal, a registration ID is determined for identification of the sampling and a sample ID is determined for identification of the sample, as well as an installation for herd management.

ID (identification) means any form of individual marking. These can be, for example, numerical or alphanumeric markings. In the course of further development of automation of herd management, the need for increasing monitoring of individual animals, especially with regard to their state of health in a herd, and due to increased requirements for the quality of the milk produced by the animals, in milk-producing operations, the acquisition of data on individual animals for herd management as well as the determination of data during the milking process becoming more and more important.

Some methods are known in the state of the art as to how information on an animal or on freshly milked milk can be acquired. For example, it is known that one can collect data on the health, on the behavior of the animal, on the quality or composition of the milk produced by the animal or on physical, chemical, biological and/or morphological properties of the milk produced by the animal, and that these can be evaluated. Especially, considering the number of different parameters that can be determined and the mass of data in a comprehensive acquisition of data an especially efficient combination of data that is proper for the practice, is not liable to errors and is reliable, is of importance.

In relation to herd management, that is, the preferably comprehensive organization of many aspects which are related to a herd, for example the feeding process, the milking process, among others, the linking of the measured data relevant to the animals with identification of the animal is centrally important. In the state of the art a number of methods and devices are known which make it possible to assign automatically the individual animal to the relevant data of the animal.

For example, it is known that one can print out a barcode on the day of investigation on the animals to be investigated and this is attached to a sample container. This method is used especially in those operations in which a milking carousel is employed. Although noting of animal numbers on the sample containers is widespread, in practice significant disadvantages arise since it is labor-intensive and liable to error.

It is also known that one can use boxes with marked numbers and have sample containers marked with numbers in it, whereby the pair of numbers, namely the box number and the sample container number, gives an unequivocal assignment. Efficient assignment of animal and sample is especially important in the so-called mixed samples (one part in the morning, one part in the evening from the same animal). At the present time the current practice is to operate with printed lists which permit assignment of animal and box number as well as sample container number. Proportionally correct composition of the sample is especially important for mixed samples, so that the amounts of milk or amounts of sample must also be given, for example, on the list. In practice the amounts of sample are determined from the amounts of milk of the two milkings using tables.

Moreover, it is known that one can use portable equipment with which a sample can be taken directly from the animal. The utility of this procedure lies in the measured results which make it possible to have immediate conclusion about the animal and its state of health or about the milk of the animal. A typical application of such portable equipment is measurement of the conductivity and temperature of the milk.

A device is known from WO 01/72115 which contains at least one milk cup with a line to a storage container in combination with testing means for investigating the milk. Furthermore, devices are contained in it for the pretreatment of the animal. However, the problem of the assignment of sample and animal is not treated in this publication.

Equipment is also known for tie-up cowsheds, with the aid of which determination of the amount of milk is possible. Such equipment so far has not had the ability to read in the place number automatically.

In order to provide the lacking relationship between sample and animal data, manual steps are required which usually consist in marking the sample. Especially in operations with a commercial orientation, for which such investigations are of interest, the liability to error and the expenditure in case of manual data input represents a serious problem which has not been solved so far. The printing of the animal numbers by a printer when the animals enter the milking parlor as well as the application of the printed labels require an increased demand for labor even in this embodiment.

In location-related measuring equipment installed in a fixed location there is a possibility of obtaining the assignment of animal and location via animal marking information. This fixed assignment of the equipment to location permits the assignment of animal data to measured data. A current realization is in the form of milking control equipment installed in a given location, which are able to determine the amount of milk. Since frequently data-technological connection to a herd management problem is already realized, all the prerequisites exist for providing the connection between animal-related data and the animal data set. Location-related expensive analytical possibilities frequently do not make sense, because these can be sensitive and cost-intensive and may use reagents. Therefore, highly specific analytical equipment related to location can be provided to start with; for this reason again the problem of increased expenditure arises in the assignment of sample and animal. Especially on sampling days when a large part of the animal stock is to be investigated, this expenditure represents significant logistics, time and cost problems.

The task of the present invention is to create a method for providing data on individual animals, in a reliable, especially efficient manner which is not prone to errors and is practicable at the same time.

According to the invention this task is solved by a method with the characteristics of claim 1. Advantageous embodiments and further developments of the method which can be used individually as well as in arbitrary combinations with one another are the objects of the dependent claims.

In the method according to the invention for providing data on individual animals, in which one sample is taken from one animal at one sampling location, whereby an animal ID for identification of the animal, a registration ID for identification of the sampling and a sample ID for the identification of the sample is determined, the animal ID, the registration ID and the sample ID determined at the sampling location, are linked to one another to form one set of information unit and are introduced into a data center.

The sample ID serves for identification of the individual sample. The sample may concern any bodily secretion of an animal, especially blood, urine and/or milk. The sample is introduced into a sample container at the sampling location and the container is then closed.

The animal ID identifies an individual animal and can be applied, for example, in the form of ear tags, injectates, bolus or as an ID label at the neck or foot.

The sampling is identified with the aid of the registration ID which can be done, for example, via the sampling position or the sampling location, the sampling time or the nature and manner of carrying out the sampling.

The animal ID, registration ID and sample ID together form an ID triplet and are combined to one information unit. For example, the information unit can be formed by a character sequence, especially a numerical sequence, whereby a first group contains at least one character that specifies the animal ID, a second group contains at least one character which reflects the registration ID, and a third group has at least one character which gives the sample ID.

With the method preferably all the data of the individual animals are expressed in combination with a sampling and are introduced into a data center. The data center can be integrated into a central data computer for herd management, but it can also be done in a decentralized manner. However, it is essential that the information units consisting of the ID triplets of a multiple number of samplings be transmitted to the data center.

With the method according to the invention it is possible to produce various linkings and to make the complete extent of the evaluations available as a tool for the analysis of the animal data. Trend lines and past values of individual animals as well as comparison values with the average of the herd or with the average or relevant animal groups are of special interest. Even when obtaining data of individual animals with equipment that is not assigned to a location in a fixed manner because, for example, they are portable, the manual expenditure is low.

For example, such equipment can control equipment for a tie-up cowshed, which detects the values for individual animals with regard to amount of milk, electrical conductivity and temperature during the milking. Furthermore, a portable measuring equipment can be one which is brought in contact with the animal or the animal's milk by the person performing the milking of the animal in order to determine measured values for the individual animal. As another representation, equipment is known which is set up in a stationary manner whereby a person performing the milking takes a sample on location, optionally after prior cooling or preparation, and brings this to the measuring equipment.

Especially with the presence of noticeable deviations from past values or other noticeable occurrences during milking, such a procedure may make sense for obtaining measured values for the individual animal. For example, the milking control equipment may indicate a high electrical conductivity during the last milking, which leads the person performing the milking to perform a detailed investigation with the portable equipment. Until now this additional expenditure made sense and could be realized only in indicated exceptional cases because it is related to additional time requirements and to analytical agents, for example reagents, depending on the measuring equipment.

In the method a continuous connection can be produced from the information from the animal, the location and the sample all the way to the result of the measuring equipment into herd management. There the various information items are linked until the animal is assigned to the result of the measuring equipment.

In a special embodiment the sample is introduced into an analytical device and the results of the analysis are linked to the information unit.

Advantageously, the animal ID, the registration ID and/or the sample ID are read in with the aid of at least one especially portable read-in device. The animal ID, the registration ID and/or the sample ID are preferably read in in a wireless manner.

Such reading-in can be done electromagnetically, especially optically or through radio. Especially the reading-in is done with the aid of at least one transponder which is attached to the animal, to the sampling location, to a sampling means and/or to a sample container for the sample.

The transponders can be carried as bolus, ear tag, injectate or conventional transponders which are carried on the foot or neck in the rumen, at the udder or at the teat or subcutaneously or at other suitable locations. This applies to transponders which are carried by the animal permanently or temporarily. In addition to the data on the individual animal, the transponders can also transmit other sensory functions, for example, activity values, pH values, or temperatures values. Furthermore, sensory values or other values can also be transmitted by the transponder. The contactless communication between the transponder and reading equipment can operate according to the radio frequency method (RF method). It is also possible to have transponder and reading equipment operate in the microwave region.

The data transfer in the direction of the reading equipment can be performed according to the half-duplex method (HDX). In a half-duplex method, the data transfer occurs displaced in time. In a full-duplex method (FDX) the transfer of power and data occur simultaneously. In the full-duplex method a sequential data transfer can occur between transmitter and receiver. Parallel data transfer between transmitter and receiver is also possible. Systems with a sequential data transfer include load modulation and the method of modulated back-radiation cross-section. In systems with parallel data transfer, the subharmonic or anharmonic methods can be used.

The sample is taken from the animal with the sampling means. The sampling means can be portable equipment with which a sample can be taken from the animal.

The read-in equipment can be designed as a scanner or as a transmitting/receiving unit. In this connection, reading-in means that the relevant data are detected so that they can be further transmitted to the data center.

The animal ID, the registration ID and/or sample ID can be deposited in the form of a barcode.

Especially, the sample IDs, however, can also be deposited in the form of locus information in a sample holder. For this purpose, the sample container with the sample is placed in a sample holder, which has characterizing data for the sample container so that the sample of an animal with the particular container can be assigned by placing the sample container in the sample holder.

Advantageously, the time of determination of the animal ID, registration ID and/or sample ID is selected by an operator, especially determined by pressing a button. With the aid of pressing the button, the residual risk of confusing the data can be reduced further.

In a special embodiment of the invention, the animal ID, registration ID and sample ID are subjected to a consistency test of the data. As a result of the redundancy created with the ID triplet, the data collection existing in the data center can be checked for any contradictions, as a result of which the incidence of error occurring during the method of acquisition of data on individual animals can be reduced.

In another special embodiment of the invention, the animal ID, the registration ID and the sample ID are evaluated within the framework of herd management. The evaluation within the framework of herd management can involve just the milking process itself, and/or taking care of the herd in general. For example, with the aid of the detected data on individual animals, the food composition or amount of food can be controlled. Veterinary aspects can also be taken into consideration, especially if an animal requires detailed examination, for example by a veterinarian.

The sampling location can be a milking station.

A further task is to create a device for providing data on individual animals, with the aid of which the data on individual animals can be determined efficiently, especially without the liability to errors and at the same time in a practicable manner.

This task is solved according to the invention by a device described in the independent claim. Advantageous embodiments and further developments which can be used individually as well is any arbitrary combination with one another are the objects of the dependent claims.

The device according to the invention for providing data on individual animals with a sampling location for taking a sample from an animal includes a first means of determination for the identification of an animal ID of the animal, a second means of determination for the identification of a registration ID of the sampling, a third means of determination for the identification of a sample ID of the sample, and transfer means with which the animal ID, the registration ID and the sample ID can be introduced into a common data center, whereby a linking means for linking the animal ID, registration ID and sample ID is arranged at the sampling location with the first, second and third means of determination.

In the linking, one information unit is formed from the animal ID, sample ID and registration ID, whereby it may be sufficient to combine the individual IDs actually only in the data center. It is of importance that the linking between the animal ID, the registration ID and the sample ID have their origin at the sampling location.

The first, second and/or third means of determination can be at least one especially portable, preferably wireless reading-in device. It can consist of a scanner, especially a barcode scanner. Alternatively, the first, second and/or third means of determination work together with a transponder which is attached to the animal, the sample holder and/or the sampling location or to the or a sampling means.

In a special embodiment of the invention, the device has a triggering means for an operator, with which the time of determination of the animal ID, registration ID and/or sample ID can be chosen. With the triggering means, which can be designed in the form of an electrical switch, the time of the particular ID determination can be selected, through which the danger of confusion of data can be reduced further.

In a further embodiment of the device, the device has a multiple number of sample containers, especially closeable sample containers, for taking samples. Advantageously, the sample holder is designed for sorting a number of sample containers. This can be realized in the form of a matrix in which a sample container receptacle is assigned to each sample container, so that the animal ID, sample ID and registration ID can be linked together through the locus information provided by the matrix.

The sampling location is advantageously a milking station.

Moreover, a task is to provide an installation for herd management which can detect and manage large amounts of animal-related data in a practicable manner and in an efficient manner that is not liable to errors.

This task is solved according to the invention, by an installation as given in the independent claim. Advantageous embodiments and further developments which can be used individually as well as in any arbitrary combination are the objects of the dependent claims.

The installation according to the invention for herd management includes a number of sampling locations and/or samplings and at least one device according to the invention.

With the aid of this installation a number of animals, especially more than 50, preferably more than 100 and especially preferably more than 150 individuals can be examined several times daily without any excessive expenditure or unacceptable error rate occurring. The installation is able to detect a mass of data efficiently and reliably so that comprehensive herd management based on data on individual animals is possible with a relatively low expenditure.

Other advantages and special embodiments will be explained with the aid of the following figure. However, the figure should not limit the invention but only illustrate it as an example.

The figure shows schematically a device according to the invention for providing data on individual animals, which is located at a sampling location 1, for example a milking parlor, with a sampling means 7, which takes a sample 2 from an animal (not shown) and stores it in a sample container 8, which is placed in a sample holder 9. The sampling means 7 is connected to a first means of determination 10. The first means of determination 10 serves for the determination of an animal ID and is designed as transponder 6, which communicates with the sampling means 7 through a wireless connection 17. Reading-in equipment 5 represents a second means of determination 11 with which a barcode located on the sample container 8 is read in shortly before or shortly after the sampling. Moreover, with the aid of locus information on the sampling means 7, the sample 2 can be identified and a sample ID can be issued by bringing the sample 2 in connection with the position of the sample container 8 in sample holder 9.Additional redundancy is thereby created, through which errors in the data acquisition can be recognized. The animal ID, together with the registration ID which is determined by a third means of determination 12 and the sample ID are linked with the aid of a linking means 14 and are transmitted through a wireless transmission connection 17 to a data center 3. Similarly, a second means of determination 11 arranged at the sampling location 1 detects the sample ID with aid of read-in equipment 5 which is designed as a barcode reader, which wirelessly transmits the registration ID to the data center 3. The data center 3 has a means for checking consistency, by checking the plausibility of the individual data links, especially if there are any contradictions in the links. Furthermore, the data center 3 is connected with an analytical device 4 through an electrical connection 18, whereby the analytical device 4 investigates sample 2 taken from an animal and transmits the measured results further to data center 3. Advantageously, a device is installed at each milking station which reads the sample ID in and in this way ensures the possibility of assignment. Preferably, it is proposed to provide the sample container 8 with a barcode ID and then to read this in at the milking station with a read-in device 5. Manual input of the sample ID at the sampling location 1, for example at the milking control equipment, can also be made possible but this demands a higher operational expenditure. The sampling means 7 is advantageously made so that it is portable. It has a triggering means 15 with which the determination of the animal ID and the registration ID can be triggered upon request by pressing a button in order to avoid assignment problems.

If the samples are deposited in a fixed, defined sequence, then assignment is possible by establishing the sequence of the stations by simply pressing a key at the milking control equipment. The milking control equipment records this pressing of the “sample” key and permits herd management to make assignments by means of the sequence of the various pressings of the “sample” key with respect to the location ID of the milk control equipment and the sample. Through the defined sequence of the samples a natural identification is provided and thus the possibility of assignment to the measured results is also made possible. In the device according to the invention, the need for manual noting of the animal and sample information is eliminated since these are transferred automatically to the data center.

In order to increase protection against error, in the case of registration ID, in addition to the identification number of the sampling means 7, the time of sampling as well as the circumstances and the nature and manner of sampling are transmitted. The stationary sampling means 7 can be arranged within or outside a milking installation, for example in a milk laboratory. Where equipment at the milking station plays a role in the assignment, they can request the operator via suitable acoustic, optical or tactile signals for reading in the sample ID with the aid of a suitable reading-in equipment. For example, one can imagine using the indication of a conductivity measurement at the milking station as an impetus for performing detailed investigation with a portable measuring equipment or to take a sample 2 for stationary measuring equipment.

Preferably, samples 2 are taken from each teat, but the method according to the invention and the device according to the invention can be applied to any types of sample that are reasonable in connection with animals. Especially all body secretions, such as blood, milk, urine, excrement and similar can be taken as sample. Especially, different or separate samples can be taken between different fractions. The first streams of milk are of special interest, especially when we are dealing with cistern milk that is not yet mixed with the alveolar milk.

The device and the method are applicable both to conventional as well as to partially or fully automatic and robot-based milk parlors. The milk parlors comprise milking installation for cows, sheep, goats, buffalo, dromedaries, horses or other animals that provide milk. In the area of animal recognition, both FDX as well as HDX as well as combined so-called full ISO components and components based on 120 kHz identifications are applicable. Similarly, milking parlor identifications are known based on recognition of animals walking by, walking through, walking over, driving by, individual location recognition, sorting, weighing and feeding. Activity measurements, pH value measurements, temperature measurements, ketose measurements, conductivity measurements, milk flow-through rate measurements, temperature measurements and others can also be performed.

The method according to the invention for providing data on individual animals in which at a sampling location 1 a sample 2 is taken from an animal, whereby an animal ID for the identification of the ID, a registration ID for the identification of the sampling and a sample ID for identification of the sample are determined, is characterized by the fact that the animal ID, the registration ID and the sample ID determined at the sampling location 1 are linked together to one information unit and are introduced into a data center 3. The method according to the invention, the device as well as the installation permit efficient, comprehensive and practicable provision and registration of a mass of data on individual animals, not liable to errors, even in the case of large stocks of animals and also permits comprehensive monitoring of an animal throughout the day.

### REFERENCE LIST

1 Sampling location
2 Sample
3 Data center
4 Analytical device
5 Read-in equipment
6 Transponder
7 Sampling means
8 Sample container
9 Sample holder
10 First means of determination
11 Second means of determination
12 Third means of determination
13 Transfer means
14 Linking means
15 Triggering means
16 Means for checking for consistency
17 Wireless transmission connection
18 Electrical connection

1. A method for providing data on individual animals at a sampling location comprising the steps of:
sampling an animal,
determining an animal ID for the identification of the animal,
determining a registration ID for identification of the sampling, and
determining a sample ID for the identification of the sample;
sending the animal ID registration ID, and sample ID to an information unit; and introducing the animal ID, registration ID, and sample ID into a data center.

2. The method according to claim 1, and further comprising the step of:
introducing the sample ID into an analytical device to obtain analysis results; and
linking the analysis results with the information unit.

3. (canceled)

4. (canceled)

5. (canceled)

6. (canceled)

7. (canceled)

8. (canceled)

9. (canceled)

10. (canceled)

11. (canceled)

12. (canceled)

13. A device for providing data on individual animals comprising:
a sampling location for taking a sample from an animal, the sampling location comprising:
a first means for identifying an animal ID of the animal;
a second means for identifying a registration ID of the sampling;
a third means for identifying a sample ID of the sample; and
a transfer means for introducing the animal ID, the registration ID and the sample ID can be introduced into a common data center, having a linking means for linking the animal ID, registration ID and sample ID and arranged with the first, second and third means of determination at the sampling location.

14. The device according to claim 13, characterized by the fact that at least one of the means for identifying a wireless, device.

15. (canceled)

16. (canceled)

17. (canceled)

18. (canceled)

19. (canceled)

20. (canceled)

21. (canceled)
